(19) United States
(12) Patent Application Publication
(10) Pub. No.: US 2022/0007680 A1
(43) Pub. Date: Jan. 13, 2022

(54) FOOD ALTERNATIVE PRODUCT AND PROCESS

(71) Applicant: Plant Meat Ltd, London (GB)

(72) Inventors: Pete Sharman, London (GB); Andy Shovel, London (GB); Florian Wild, London (GB)

(21) Appl. No.: 17/283,912

(22) PCT Filed: Oct. 17, 2019
(86) PCT No.: PCT/GB2019/052970

§ 371 Date: Apr. 8, 2021

(30) Foreign Application Priority Data
Oct. 17, 2018 (GB) 1816927.6

(51) Int. Cl. A23J 3/22; A23J 3/16; A23J 3/26; A23P 30/25

(52) U.S. Cl. CPC A23J 3/227; A23P 30/25; A23J 3/26; A23J 3/16

(57) ABSTRACT

A high moisture extrusion apparatus suitable for manufacturing foodstuffs is disclosed herein. The apparatus includes an extruder barrel having an inlet port for input of a first material into the extruder barrel, an injection port for input of a second material into the extruder barrel, and an outlet port for output of a combination of the first and second material from the extruder barrel. The injection port is located intermediate to the inlet and outlet port, and closer to the outlet port than the inlet port.

The present patent document is a § 371 nationalization of PCT Application Serial No. PCT/GB2019/052970, filed Oct. 17, 2019, designating the United States, which is hereby incorporated by reference, and this patent document also claims the benefit of Great Britain Patent Application No. 1816927.6, filed Oct. 17, 2018, which is also hereby incorporated by reference.

### FIELD

The present disclosure relates to a food product and process. In particular, the disclosure relates to a method for producing a meat alternative product by using a high moisture extrusion process, whilst maximizing the marbling coloring effect in the meat alternative product and maintaining vitamins and flavors in the extruded product. It is, for example, applicable to vegetarian or vegan analogues to meat or fish.

### BACKGROUND

Veganism and vegetarianism is an increasingly common lifestyle choice around the globe, and particularly in the UK and USA. Veganism is defined as not consuming dairy, meat, fish, or egg products. This means that their diet must consist of plant-based food products that maintain the highest sources of nutrients. Vegetarianism is defined as the practice of not eating meat or fish. As a result of this change in eating habits among the general population, there is an increased demand for meat free protein products and meat alternatives.

Additionally, issues around health, sustainability, traceability, and animal welfare are also increasingly important influences in consumer purchasing decisions. As a result, meat free protein products are no longer exclusively sold to the consumer group that identifies as vegetarian or vegan. A flexible diet is becoming increasingly popular and the appeal of plant-based foods is broadening to include people who also incorporate meat and dairy in their diets but also wish to seek meat alternatives sometimes.

One method used to generate meat alternative products is through high moisture extrusion. High moisture extrusion cooking of plant or vegetable proteins (e.g., soy) has recently started being used to produce meat analogues. High moisture extrusion cooking is a process that allows the formation of a strand or larger pieces from protein rich powders, slurries, or small pieces such as plant proteins or meat and fish. Plant proteins may be mixed with water in an extruder barrel and the combination of heating and subsequent cooling of the mixture facilitates the texturization and creation process to produce a layered or fibrous structure with a ‘meat-like’ appearance. There are several variables in the process of high moisture extrusion that may affect the end product. Raw material characteristics from various sources (wheat, soya, pea, chickpea, fava bean, lupine, or other grain legumes and oilseeds such as rapeseed, sunflower, linseed, and others) and from various manufacturing, protein purification and drying procedures (flours, press cakes, protein extracts, concentrates or isolates; defatted and/or dried products as well as slurries). Further, the extruder and process design dictate the formation of fibrous structures like that of meat. Additionally, system parameters such as throughput, pressure, water content, and temperature profile are also considered.

Whilst high moisture extrusion is an effective method for producing a layered or fibrous structure like meat or fish, the outcome product may not look like meat or fish. This may be off-putting for consumers who prefer the look of and are more comfortable with the overall appearance of meat and fish. Organic coloring ingredients used to create meat analogues, such as plant extracts from red beetroot, paprika, red radish, or black carrot do not withstand the high temperatures and fade or turn to unwanted brownish or dark colors. Additionally, heat sensitive flavoring compounds and spices as well as other heat sensitive ingredients such as vitamins may be destroyed, inactivated, or denatured in the mixing process under high temperature or simply get lost in the vapor phase.

For example, owing to the unusually high-water content in the processed mass and to the elevated temperature, the mass viscosity in the extruder is relatively low. Therefore, under typical processing conditions, mixing the mass within the extruder barrel is very effective. Therefore, added colorants are within very short processing time almost equally distributed and demonstrating no clear marbling effect remains. A method of achieving marble coloring and/or effect and maintaining vitamins and flavorings is needed.

### SUMMARY

The present disclosure seeks to address these, and other, disadvantages encountered in the prior art by providing an improved method of moisture extrusion.

The scope of the present disclosure is defined solely by the appended claims and is not affected to any degree by the statements within this summary. The present embodiments may obviate one or more of the drawbacks or limitations in the related art.

### BRIEF DESCRIPTION OF THE DRAWINGS

The present disclosure will now be described, by way of example only, with reference to the accompanying drawings.

FIG. 1 shows a cross sectional view of a high moisture extrusion apparatus according to a first embodiment of the disclosure.

FIG. 2 shows a cross sectional view of a high moisture extrusion apparatus according to a further embodiment of the disclosure.

FIG. 3 shows a cross sectional view of a high moisture extrusion apparatus according to a further embodiment of the disclosure.

FIG. 4 shows a flowchart of an exemplary production line for suitable for high moisture extrusion.

### DETAILED DESCRIPTION

The present disclosure will now be described by way of example only. These are not the only ways that the disclosure may be put into practice.

In overview, colorants or other ingredients into the extruder barrel are used for various reasons. For injection, a low-pressure zone within the extruder barrel may be chosen or created to make the injection easier. The newly added material or liquids may have a considerably lower dry matter content compared to the processed mass already in the barrel. Because of this, conventionally the amount of lower dry matter content added towards the end of barrel (an area of high pressure) is limited as it causes unsteady, irregular process conditions due to the high pressure.

This disclosure is directed towards a high moisture extrusion apparatus and method for producing foodstuffs. Primarily the disclosure is directed towards the late injection of a colorant or flavoring to produce a marbling effect and to maintain vitamins and flavors in an extruded product. A second aspect of the disclosure is directed towards a high-pressure pump used in the high moisture extrusion apparatus to allow the late insertion of colorants and flavorings. A high-pressure pump may be used to allow for colorants or flavorings to be inserted at a later stage in the high moisture extrusion process where the pressure is very high, contrary to known approaches where the high-pressure area is avoided for practical reasons. It is found that, as a result, improved marble coloring and/or effect and maintenance of vitamins and flavorings is achieved.

By way of background, as is well known, extrusion is a continuous mixing, kneading, and shaping process used to produce a desired product. Food extrusion is not new to the food industry and has been utilized to produce many different types of food products for more than 60 years. Well known extrusion applications in the food industry include pasta, breakfast cereals, baby food, pet food, and other confectionery products. Almost all of these applications take place at low to intermediate level moisture contents (e.g., for a water weight of less than 40%).

High moisture extrusion is a relatively new type of extrusion. High moisture extrusion cooking describes a process that allows the formation of strands or larger pieces from protein rich powders, slurries, or small pieces such as plant proteins, meat, and fish. High-moisture extrusion cooking of plant proteins has recently gained increasing attention for producing meat alternatives. The combination of heating and subsequent cooling of the protein—water mixture facilitates the texturization of the product and produces a layered or fibrous structure with a ‘meat like’ appearance. High moisture extrusion is characterized by processing materials with a high-water content, compared to traditional extrusion methods. The materials used in high moisture extrusion may have a water weight higher than 40% or higher than 50%. Due to the unusual high-water content in the processed materials and due to the elevated temperature needed to produce the desired effect, the viscosity of the material in the extruder is relatively low (e.g., a creamy, purée like texture). The viscosity and high temperature means that, under typical processing conditions, mixing the materials within the extruder barrel is very effective. Counterintuitively, this may adversely affect, for example, the appearance of conventionally marbled products. High moisture extrusion may therefore be combined with a twin-screw extruder for making unconventional food products.

The high moisture extrusion process may be affected by several independent process variables such as raw material characteristics, the high moisture extrusion apparatus, and process design on the formation of fibrous structures. Concurrently, dependent system parameters such as pressure, temperature, and changes at a molecular level with focus on protein—protein interactions also significantly affect the extruded product. In particular, the process is sensitive to a combination of parameters such as the temperature profile in the extruder, the exposed temperature of the injected products, the selected place of injection, the screw profile of the extruder, quantity of the injected liquid, composition of the injected liquid, and frequency of the injection. These factors are all considered in this application.

The high moisture extrusion process described herein is also characterized by a high protein content. A combination of heating and subsequent cooling of foodstuffs in the extruder barrel facilitates texturization of the resultant foodstuff. In particular, the heating and cooling of protein and water mixtures facilitates the texturization to produce a layered or fibrous structures with a ‘meatlike’ appearance. Independent process variables such as raw material characteristics as well as extruder and process design on the formation of fibrous structures all have an effect of the output foodstuff product. Concurrently, the effects of dependent system parameters such as pressure, temperature, and changes at a molecular level with focus on protein—protein interactions have also been taken into consideration. A large number of parameters directly influence the product's quality and are therefore carefully adjusted to obtain products with fibrous meatlike properties.

When producing ‘meat-like’ products, the aim is to create an extruder environment where the extruded product is layered and fibrous with a strand-like texture, similar to that of ‘real’ meat. This is achieved by using high moisture content. Notably, this is distinctly different from the extrusion process used to create sugar-based products. Sugar based products may be made with a relatively lower moisture content to achieve an even and smooth texture and uniform sugar distribution, for example, chewing gum. Conversely, the aim with ‘meatlike’ products is to provide the more fibrous texture.

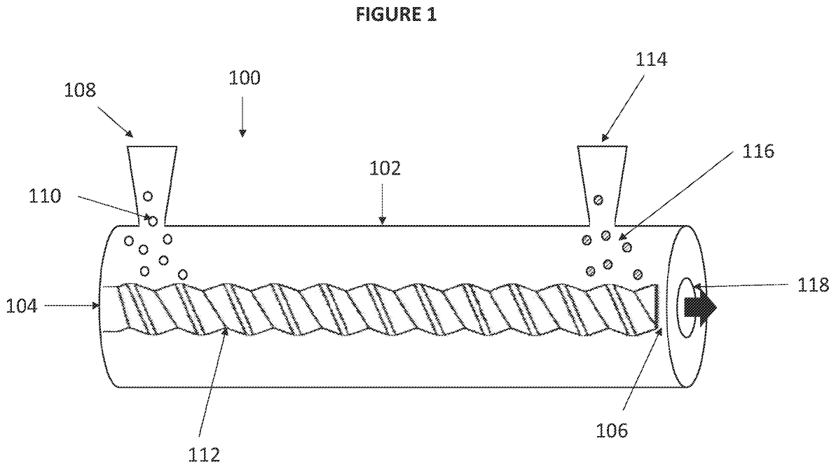

Referring to FIGS. 1 to 3, a high moisture extrusion apparatus 100 is shown and is suitable for manufacturing foodstuffs. The high moisture extrusion apparatus 100 includes an extruder barrel 102. The extruder barrel 102 may take various shapes, for example a cylindrical or cuboid shape. The extruder barrel 102 may be formed of metal, most common type of metal used are nitriding steels, powder metallurgy steels, or bi-metals which are composed by two separates parts: a support base material and an internal lining. The extruder barrel 102 may be a heated extruder barrel. A heated extruder barrel 102 is used to provide the materials inside the extruder barrel 102 are at the ideal temperature needed to form protein strand structures suitable for consumption. The heated extruder barrel 102 may have a heated exterior dissipating heat into the interior of the extruder barrel 102.

The extruder barrel 102 includes an inlet port 108 and an outlet port 118. The extruder barrel 102 has an inlet end 104 at or near which the inlet port 108 is located and an outlet end 106 at or near which the outlet port 118 is located. The inlet port 108 and the outlet port 118 may be located at opposing ends of the extruder barrel 102 or respectively downstream and upstream thereof. The extruder barrel 102 further includes an injection port 114.

The extruder barrel 102 may include more than one inlet port 108. For example, the inlet port 108 may include a first inlet port, a second inlet port and optionally a third inlet port. The first inlet port may be used to input a dry powder mix (e.g., soy), the second inlet port may be used to input water, and the third inlet port may be used to input oils into the extruder barrel 102.

The inlet port 108 is for input of a first material 110. The injection port 114 is for input of a second material 116. The outlet port 118 is for output of a combination of the first material 110 and the second material 116 from the extruder barrel 102. The injection port 114 is located intermediate to the inlet port 108 and the outlet port 118. The injection port 114 may be located closer to the outlet port 118 than the inlet port 108. The injection port 114 may be located adjacent to the outlet port 118. The outlet port 118 and injection port 114 may both be located at the outlet end 106 of the barrel.

The injection port 114 may be located anywhere along the extruder barrel 102. Several possible locations for the injection port 114 are given below.

Firstly, the injection port 114 may be located after the inlet port 108 (e.g., after the feeding of the first material 110) and closer to the inlet port 108 than the outlet port 118. This has the advantage of being in a relatively low-pressure zone to allow easy injection of the second material 116. However, the second material 116 will still have a long residence time in the extruder barrel 102, which has a high thermal impact on sensitive components and a high level of mixing which leads to equal distribution of the components within the mass and therefore a reduced marbling effect.

Secondly, the injection port 114 may be located closer to the outlet port 118 than the inlet port 108. In this case the injection port 114 is not located in the high-pressure zone directly next to outlet port 118. As the injection port 114 approaches the outlet port 118 of the extruder barrel 102, the second material 116 has a shorter residence time, therefore there is smaller thermal impact, lower mixing efficiency (but sometimes still high enough to produce an equal distribution of the inserted second material 116). Pressure at the injection port 114, in this area, depends on the screw profile and may be either high or low. It is desirable to place the injection port 114 somewhere with the low pressure, this depends on the impeller or screw profile.

Thirdly, the injection port 114 may be located close to the outlet port 118. The injection port 114 may be located within a region of 10% of the outlet port 118 compared to the entire length of the extruder barrel 102. In this extrusion process, the material is forced through a die section at the outlet port 118 in order to form the material into a strand or particular shape. This is aided by the cooled slit channel. As a consequence of forcing the material into a smaller region, the pressure rises in the area behind the outlet port 118. The pressure is highest where the cross-sectional area of the die section is at its minimum. When the injection port 114 is located close to the outlet port 118, there is a short residence time in the extruder barrel 102. Therefore, there is a moderate thermal impact on sensitive components and moderate mixing in the extruder barrel 102. This leads to an unequal distribution of the second material 116 within the final extruded product and greater marbling effect. However, as the second material 116 is inserted into a high-pressure zone, a sophisticated injection system is used. Further, the addition of a relatively lower viscosity second material 116 to the first material 110 may lead to an unsteady slow and unstable processing conditions.

The first material 110 may include a protein rich powders, slurries, or small pieces such as plant protein or meat and fish. The first material 110 will also include a high level of water. The first material 110 has a first weight and, in certain examples, more than 40% of the total first weight will be water. The water content is needed to provide the high moisture extrusion process may occur effectively in the extruder barrel 102.

The second material 116 may include a colorant or flavoring or other nutrients (e.g., vitamins) or combination of both a colorant, flavoring, or nutrient. For example, the second material may include organic coloring ingredients, such as plant extracts from red beetroot, saffron, paprika, red radish, and/or black carrot. In conventional arrangements, these ingredients do not withstand the high temperatures present in the extruder barrel 102 and fade or turn to unwanted brownish or dark colors. Additionally, the second material 116 may also include heat sensitive flavoring compounds, spices, and/or vitamins. These compounds are prone to denaturing under high temperatures.

However, the present disclosure is directed towards solving these problems and ensuring that colorants and flavorings are effective in the extruded product (e.g., a combination of the first material 110 and second material 116).

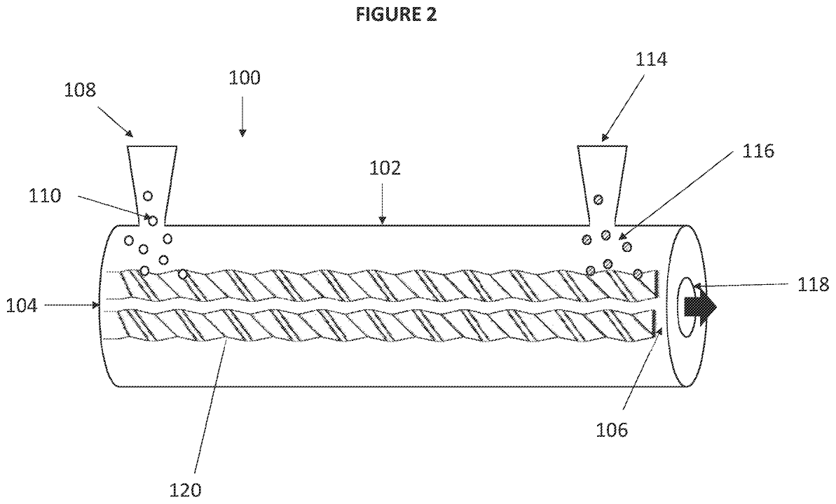

As shown in FIG. 1, the high moisture extrusion apparatus may further include an impeller 112. The impeller may be a screw or other type of mechanical device rotatable inside the extruder barrel 102. The impeller 112 is located inside the extruder barrel 102. The impeller 112 is configured to move the first material 110 and second material 116 from the inlet end 104 to the outlet end 106 of the extruder barrel 102. The impeller 112 may be located at the inlet end 104 of the extruder barrel 102. The impeller 112 may extend the entire length of the extruder barrel 102. As shown in FIG. 2, the impeller may include a twin-screw extruder system 120. A twin-screw extruder system 120 includes, for example, two intermeshing, co-rotating screws. The twin screw extruder system 120 may be mounted on inlet end 104 inside the extruder barrel 102. There are a wide range of twin-screw designs, various screw profiles, and process functions that may be used depending on the requirements of the extruded product. While co-rotating, intermeshing screws are widely used for low to high viscous materials other types of screw designs such as counter rotating screws or multi-screws (more than two screws) are known as well.

A twin-screw extruder system 120 ensuring effective transporting, compressing, mixing, cooking, shearing, heating, cooling, pumping, shaping, etc. with high level of flexibility. The major advantage of intermeshing co-rotating twin screw extruders is their remarkable mixing capability which provides characteristics to extruded products and adds significant value to processing units, for example, when compared to a single screw impeller 112.

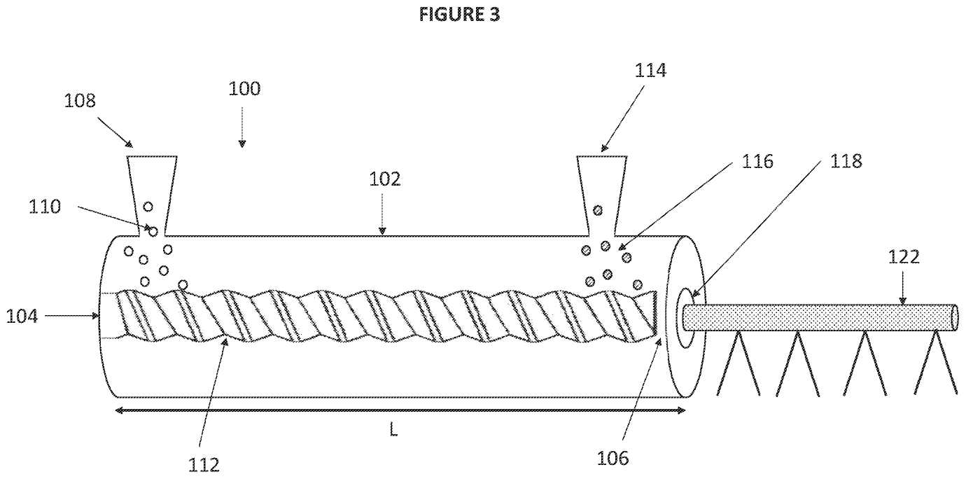

As shown in FIG. 3, the high moisture extrusion apparatus may also include a slit channel 120. The slit channel may be attached to the outlet port 118, however, it may also be situated further downstream from the outlet port. The slit channel 120 may be used in the high moisture extrusion apparatus used to regulate the temperature and shape of the extruded product. The slit channel 120 stabilizes the flow coming out of the extruder barrel and may also be formed to shape the combined first material and second material into a desirable product. Therefore, the slit channel 120 may be formed into various shapes and have various lengths depending on the desired product. The high moisture levels in the high moisture extrusion apparatus 100 combined with elevated temperatures in the extruder barrel 102 may produce a material that is very soft and not self-supporting. However, in one embodiment, the extruder may have a cooled slit channel 122 specially designed which provides cooling at this section will increase the viscosity of the hot extrudate before exiting, contributing to the correct elasticity and fluidity required for texturization. The cooled slit channel 122 may be a long die section.

The extruder barrel 102 necessarily has a differential pressure along the extruder barrel 102 (see the length L denoted in FIG. 3), where the pressure is greater at the outlet port 118 than the input port 104. The pressure may be a maximum or at least relatively high at or close to the outlet port 118 of the extruder barrel 102. As a result, in certain embodiments, the injection port 114 includes a high-pressure pump. As a late injection point of the second material is desired, this may be done within a high-pressure zone within the extruder barrel 102 that demands a high-pressure pump to overcome the high pressure within the extruder barrel 102. Therefore, a high-pressure pump is used to allow the second material 116 to be fed into the extruder barrel 102.

The high-pressure pump may be piston pump or a diaphragm pump. The high-pressure pump may be configured to exert a pressure greater than the pressure within the extruder barrel 102 at the outlet port 118. The high-pressure pump may be located in a region where the pressure is greater than the midpoint of the differential pressure. The closer the injection port 114 is located to the outlet port 118 the less mixing that the second material 116 will experience, leading to more marbling. However, the higher the pressure at the outlet port 118, the higher the risk of unstable processing conditions.

A method of high moisture extrusion suitable for manufacturing foodstuffs is disclosed herein. The method of high moisture extrusion is suitable for manufacturing foodstuffs. The method is formed from several steps. In one act, a first material 110 is input into an extruder barrel 102 through an inlet port 108. In an additional act, a second material 116 is input into the extruder barrel through an injection port 114. In a further act, a combination of the first and second material is output through an outlet port 118 of the extruder barrel 102. In the described method, the second material is input adjacent to the outlet end. The first material 110 may be fed into the extruder barrel 102 close to the input end 104 of the extruder barrel and the second material 116 is fed into the extruder barrel 102 close to the output end 106 of the extruder barrel 102.

It is desirable to inject the second material 116 at a late stage in extrusion process with the extruder barrel 102. Injection takes place intermediate to the inlet port 108 and the outlet port 118. The injection may take place closer to the outlet port 118 than the inlet port 108. The injection of the second material 116 may take place adjacent to the outlet port 118. The injection may take place at the outlet end 106 of the barrel.

These ingredients are fed at the inlet ports of the extruder that are located close to one end of the extruder screws. Within the extruder barrel one or more impellers push the fed material forward to the other end of the extruder barrel. Thereby, the impeller 112 mixes the first material 110 and second material 116 and heats them by dissipating mechanical energy. At the outlet of the extruder barrel there may be a slit channel 122 attached to form the mass and to cool it down prior to the release to atmosphere. Additionally, the slit channel may be a cooled slit channel to reduce the temperature of the extruder product more quickly. The mass may be heated during the transfer of the extruder barrel to a temperature of 100-150° C. while pressures of up to around 50 bar or more towards the screws end may be reached.

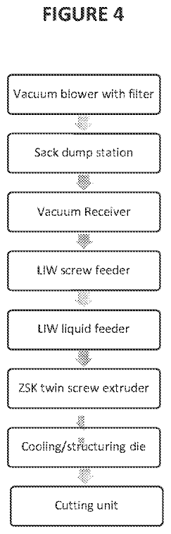

FIG. 4 shows a how the high moisture extrusion apparatus 100 may fit into a wider production line for generating foodstuffs and more specifically for generating meat alternatives.

The disclosure thus provides advantages based on a combination of temperature profile in the extruder barrel and slit die, the exposed temperature to the mass, the selected place of injection, the screw profile of the extruder, quantity, and composition of the injected liquid as well as frequency of the injection.

Because injection takes place at a late stage of the extrusion process, the remaining processing time until the entry into the cooling die is sufficiently short that the increase of temperature does not lead to a rapid degradation. Also, the efficient cooling of the material once entered into the cooled slit channel helps to maintain heat sensitive components. On the other hand, the amount of injected mass is relatively low not to provoke a sudden decrease in temperature in the mix of first material 110 and second material 116 and respectively a sudden strong increase in viscosity that may disturb the stability of the process. A minor decrease in temperature may be helpful to maintain heat sensitive components.

As discussed previously, the viscosity of the first material 110 in the extruder barrel 102 is relatively low. In other words, under typical processing conditions mixing the mass within the extruder barrel is too effective. Therefore, when the second material 116 is added at a late stage in the process, there is a short processing time and the colorants and flavorings are not evenly mixed in the extruder barrel 102. This generates a marbling effect in the extruded product.

In certain examples, late injection takes place in a high-pressure zone within the extruder barrel 102. When adding liquids with a considerably lower dry matter content compared to the processed mass is limited, this also causes the extruder barrel to become unsteady and irregular process conditions are present. The high-pressure pump is sufficiently adequate to control the amount of injection accurately.

The extruder barrel 102 may be a heated extruder barrel. The first material may be provided with a temperature high enough such that the desired product may be formed, with strands and layered formation whilst also maintaining a low enough temperature such as not to denature colorants and flavorings added through the injection port 114. The extruder barrel 102 may be configured to provide the first material with a temperature below 150° C. The extruder barrel 102 may be configured to provide the first material with a temperature below 130° C. The first material may be provided at a temperature below 130° C. to provide that the colorants and flavoring do not become immediately denatured upon contact with the first material 110. The extruder barrel 102 may be configured to provide the first material and the second material with a temperature below 130° C. This is particularly applicable at towards the outlet end 106 of the extruder barrel 102, where both a combination of the first material 110 and second material 116 is present. The extruder barrel 102 may be configured to provide the second material 116 with a temperature below 130° C. Again, this provides that the colorants and flavorings are at the ideal temperature for high moisture extrusion whilst not becoming denatured. The high moisture extrusion apparatus may be configured such that the second material 116 is provided with a temperature lower than the temperature of the first material 110.

The high moisture extrusion apparatus 100 may be configured such that the injection port 114 is configured to input a second material in liquid or solid form. The high moisture extrusion apparatus 100 may be configured such that the injection port 114 is configured to input a second material 116 in liquid form, such that the mass of the second material is 0.1-10 wt. % of the total combined mass of the first and second material. The high moisture extrusion apparatus 100 may be configured such that injection port is configured to input a second material 116 in solid form and the mass of the second material is 0.1-50 wt. % of the total combined mass of the first and second material.

Residence time is the duration of time the second material spends in the extruder barrel 102 after injection takes place. In certain examples, the residence time is below 2 minutes, or below 1 minute. The high moisture apparatus 110 may be configured such that the second material 116 resides in the extruder barrel 102 for less than 1 minute after insertion through the injection port 114. This provides that the second material 116 does not spend too long mixing in the extruder barrel 102. Too long spent mixing the first material 110 and second material 116 together would mean that they become uniformly mixed. Instead, less than 1 minute have been determined as an optimum time to provide that a marbling effect of colorants may be seen in the extruded product.

The high-pressure pump may be configured to inject the second material 116 into the extruder barrel 102 at a variable rate. The variable rate of injection is between 10 injections per minute and 250 injections per minute. The high-pressure pump is configured to inject between 0.001 and 0.05 percent of the total mass flow 110+116 of second material 116 per injection. Variable injection also aids the marbling effect in the extruder product by ensuring an ununiform mixture of the second material 116.

This high moisture extrusion method and apparatus may be used for making lots of general food products, (e.g., pasta, breakfast cereals, baby food, pet food, and other confectionery products). In particular, the method is particularly suitable for producing meat analogues.

Although the disclosure has been described and illustrated more specifically in detail by the exemplary embodiments, the disclosure is not restricted by the disclosed examples and other variations may be derived therefrom by a person skilled in the art without departing from the scope of protection of the disclosure. It is therefore intended that the foregoing description be regarded as illustrative rather than limiting, and that it be understood that all equivalents and/or combinations of embodiments are intended to be included in this description.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

1. A high moisture extrusion apparatus (100) suitable for manufacturing foodstuffs, comprising:
an extruder barrel (102) comprising;
an inlet port (108) for input of a first material (110) into the extruder barrel;
an injection port (114) for input of a second material (116) into the extruder barrel;
an outlet port (118) for output of a combination of the first and second material from the extruder barrel,
wherein the injection port is located intermediate to the inlet and outlet port, and closer to the outlet port than the inlet port.

2. The high moisture extrusion apparatus (100) of claim 1 wherein the injection port (114) is located adjacent to the outlet port (118).

3. The high moisture extrusion apparatus (100) of claim 1 wherein the outlet port (118) and injection port (114) are located at an outlet end (106) of the barrel.

4. The high moisture extrusion apparatus (100) of any preceding claim further comprising a slit channel (120), located outside the extruder barrel (102) and attached to the outlet port (118).

5. The high moisture extrusion apparatus (100) of claim 4 wherein the slit channel (122), is a cooled slit channel.

6. The high moisture extrusion apparatus (100) of any preceding claim wherein the extruder barrel (102) is a heated barrel.

7. The high moisture extrusion apparatus (100) of claim 6 wherein the extruder barrel is configured to provide the first material (110) with a temperature below 150° C.

8. The high moisture extrusion apparatus (100) of claim 6 wherein the extruder barrel (102) is configured to provide the first material (110) with a temperature below 130° C.

9. The high moisture extrusion apparatus (100) of claim 6 wherein the extruder barrel (102) is configured to provide the first material (110) and the second material (116) with a temperature below 130° C.

10. The high moisture extrusion apparatus (100) of claim 6 wherein the extruder barrel is configured to provide the second material (116) with a temperature below 130° C.

11. The high moisture extrusion apparatus (100) of any preceding claim configured such that the second material (116) is provided with a temperature lower than the temperature of the first material (110).

12. The high moisture extrusion apparatus (100) of any preceding claim further comprising an impeller (112) located inside the extruder barrel (102).

13. The high moisture extrusion apparatus (100) of claim 12 wherein the impeller (112) is located at an inlet end (104) of the extruder barrel (102).

14. The high moisture extrusion apparatus (100) of claim 12 or 13 wherein the impeller is configured to push the first material (110) and second material (116) towards the outlet end (106) of the extruder barrel (102).

15. The high moisture extrusion apparatus (100) of claims 12 to 14 wherein the impeller comprises a twin screw extruder system (120).

16. The high moisture extrusion apparatus (100) of any preceding claim wherein the inlet port (108) is provided at an inlet end (104).

17. The high moisture extrusion apparatus (100) any preceding claim configured such that the injection port (114) is configured to input the second material (116) in liquid form, such that the mass of the second material is 0.1-10% of the total combined mass of the first (110) and second material.

18. The high moisture extrusion apparatus (100) of claims 1 to 16 configured such that injection port is configured to input a second material (116) in solid form and the mass of the second material is 1-50% of the total combined mass of the first and second material.

19. The high moisture extrusion apparatus (100) of any preceding claim configured such that the second material (116) resides in the extruder barrel (102) for less than 2 minutes after insertion through the injection port (114).

20. The high moisture extrusion apparatus (100) of any preceding claim wherein the extruder barrel (102) has a differential pressure along the extruder barrel, wherein the pressure is greater at the output port (118) than the input port (104).

21. The high moisture extrusion apparatus (100) of claim 20 wherein the pressure is maximum at the output port (118) of the extruder barrel (102).

22. The high moisture extrusion apparatus (100) of any preceding claim wherein the injection port (114) comprises a high pressure pump.

23. The high moisture extrusion apparatus (100) of claim 22 wherein the high pressure pump is a piston pump or a diaphragm pump.

24. The high moisture extrusion apparatus (100) of claim 22 or 23 wherein the high pressure pump is configured to inject the second material (116) at a variable rate.

25. The high moisture extrusion apparatus (100) of claim 24 wherein the variable rate of injection is between 10 injections per minute and 250 injections per minute.

26. The high moisture extrusion apparatus (100) of claim 24 or 25 wherein the high pressure pump is configured to inject 0.2 ml to 5 ml of second material (116) per injection.

27. The high moisture extrusion apparatus (100) of claim 24 or 25 wherein the high pressure pump is configured to inject between 0.001% and 0.05% of the total combined mass of the first material (110) and second material (116) per injection.

28. The high moisture extrusion apparatus (100) of claims 22 to 27 wherein the high pressure pump is configured to exert a pressure greater than the pressure within the extruder barrel (102) at the output port (118).

29. The high moisture extrusion apparatus (100) of any of claims 22 to 28 when dependent on claim 20 or 21 wherein the high pressure pump is located in a region where the pressure is greater than the midpoint of the differential pressure.

30. The high moisture extrusion apparatus (100) of any preceding claim wherein the inlet port comprises a first inlet port and a second inlet port.

31. The high moisture extrusion apparatus (100) of claim 30, wherein the inlet port further comprises a third inlet port.

32. A high moisture extrusion apparatus (100) suitable for manufacturing foodstuffs, comprising:
an extruder barrel (102) comprising;
an inlet port (108) for input of a first material (110) into the extruder barrel;
an injection port (114) for input of a second material (116) into the extruder barrel;
an outlet port (118) for output of a combination of the first and second material from the extruder barrel,
wherein the injection port comprises a high pressure pump.

33. The high moisture extrusion apparatus (100) of claim 32 wherein the high pressure pump is a piston pump or a diaphragm pump.

34. The high moisture extrusion apparatus (100) of claim 32 or 33 wherein the high pressure pump is configured to inject the second material (116) at a variable rate.

35. The high moisture extrusion apparatus (100) of claim 34 wherein the variable rate of injection is between 10 injections per minute and 250 injections per min.

36. The high moisture extrusion apparatus (100) of claim 34 or 35 wherein the high pressure pump is configured to inject 0.2 ml to 5 ml per injection.

37. The high moisture extrusion apparatus (100) of claim 34 or 35 wherein the high pressure pump is configured to inject between 0.001% and 0.05% of the total combined mass of the first material (110) and second material (116) per injection.

38. The high moisture extrusion apparatus (100) of claims 32 to 37 wherein the high pressure pump is configured to exert a pressure greater than the pressure within the extruder barrel (102) at the output end (118).

39. The high moisture extrusion apparatus (100) of any of claims 32 to 38 wherein the extruder barrel has a differential pressure along the extruder barrel (102), wherein the pressure is greater at the output port (118) than the input port (104).

40. The high moisture extrusion apparatus (100) of claim 39 wherein the pressure is maximum at the output port (118) of the extruder barrel (102).

41. The high moisture extrusion apparatus (100) of claim 39 or 40 wherein the high pressure pump is located in a region wherein the pressure is greater than the midpoint of the differential pressure.

42. The high moisture extrusion apparatus (100) of any of claims 32 to 41 wherein the inlet port comprises a first inlet port and a second inlet port.

43. The high moisture extrusion apparatus (100) of claim 42, wherein the inlet port further comprises a third inlet port.

44. A method of high moisture extrusion suitable for manufacturing foodstuffs, comprising the steps of:
inputting a first material (110) into an extruder barrel (102) through an inlet port (108);
inputting a second material (116) into the extruder barrel through an injection port (114);
outputting a combination of the first and second material through an outlet port (118) of the extruder barrel;
wherein the second material is input intermediate to the inlet and outlet port, and closer to the outlet port than the inlet port.

45. A foodstuff product obtained by the process of high moisture extrusion of claim 44.

46. A method of high moisture extrusion suitable for manufacturing foodstuffs, comprising the steps of:
inputting a first material (100) into an extruder barrel (102) through an inlet port (108);
inputting a second material (116) into the extruder barrel through an injection port (114);
outputting a combination of the first and second material through an outlet port (118) of the extruder barrel;
wherein the second material is input through a high pressure pump.

47. A foodstuff product obtained by the process of high moisture extrusion of claim 46.
